(19) United States
(12) Patent Application Publication
(10) Pub. No.: US 2025/0354711 A1
(43) Pub. Date: Nov. 20, 2025

(54) INTELLIGENT MANAGEMENT METHOD AND SYSTEM FOR PRODUCTION ENVIRONMENT OF PLANT

(71) Applicant: CLP Three Company, Chengdu City (CN)

(72) Inventors: Jinpeng HUO, Chengdu City (CN); Jiaxin QIN, Chengdu City (CN); Qiang ZHANG, Chengdu City (CN); Yichuan WANG, Chengdu City (CN); Zhixiang JIN, Chengdu City (CN)

(21) Appl. No.: 19/203,397

(22) Filed: May 9, 2025

(30) Foreign Application Priority Data
May 15, 2024 (CN) 202410598042.3

(51) Int. Cl. F24F 11/65; F24F 3/167; F24F 120/10; G06T 7/00; G06V 10/44; G06V 20/52; G06V 40/10

(52) U.S. Cl. CPC F24F 11/65; F24F 3/167; G06T 7/0004; G06V 10/443; G06V 10/457; G06V 20/52; G06V 40/10; F24F 2120/10; G06T 2207/30196; G06T 2207/30242

(57) ABSTRACT

Provided are an intelligent management method and system for a production environment of a plant, belonging to the technical field of plant centralized control. The method includes: acquiring device attribute information of a target device stored in a target plant workshop by a high-definition camera at first timing, and predicting and analyzing the device attribute information to acquire a first target cleanliness index corresponding to the device attribute information; acquiring entry-exit feature information of the target plant workshop by the high-definition camera at second timing, and predicting and analyzing according to the entry-exit feature information to acquire a second target cleanliness index corresponding to the entry-exit feature information; and determining a cleanliness control parameter according to the first target cleanliness index and the second target cleanliness index, and controlling multiple FFU devices to filter air in the target plant workshop according to the cleanliness control parameter.

### CROSS-REFERENCE TO RELATED APPLICATION

This patent application claims the benefit and priority of Chinese Patent Application No. 202410598042.3 filed with the China National Intellectual Property Administration on May 15, 2024, the disclosure of which is incorporated by reference herein in its entirety as part of the present application.

### TECHNICAL FIELD

The present disclosure relates to the technical field of centralized control of the plant, and in particular to an intelligent management method and system for a production environment of a plant.

### BACKGROUND

Due to the environmental requirements of precision machinery industry (e.g., the machining of gyroscopes, micro bearings, etc.) and semiconductor industry (e.g., the production of large-scale integrated circuits), the environmental cleanliness of production plants needs to be regulated with high precision. The cleanliness control of existing production plants is achieved according to the preset cleanliness index, that is, the air in the target plant workshop is filtered by a fan filter unit (FFU) device to keep the cleanliness in the target plant workshop at the preset cleanliness index. However, the production device and goods in the target plant workshop are changeable, and different production devices and goods have different requirements for cleanliness. The above preset cleanliness index cannot adapt to the different requirements, and excessively high preset cleanliness index may lead to unnecessarily high power consumption of the FFU device, and manual adjustment may lead to low efficiency.

### SUMMARY

In order to solve the technical problems in the background art, the present disclosure provides an intelligent management method and system for a production environment of a plant, an electronic device, and a computer storage medium.

The present disclosure provides an intelligent management method for a production environment of a plant, including the following steps:
acquiring device attribute information of a target device stored in a target plant workshop by a high-definition camera at first timing, and predicting and analyzing the device attribute information to acquire a first target cleanliness index corresponding to the device attribute information;
acquiring entry-exit feature information of the target factor workshop by the high-definition camera at second timing, and predicting and analyzing the entry-exit feature information to acquire a second target cleanliness index corresponding to the entry-exit feature information; and
determining a cleanliness control parameter group according to the first target cleanliness index and the second target cleanliness index, and controlling multiple FFU devices to filter air in the target plant workshop according to the cleanliness control parameter group.

The acquiring device attribute information of a target device stored in a target plant workshop by a high-definition camera includes:
acquiring appearance feature information of the target device stored in the target plant workshop by the high-definition camera, and analyzing an integrity index of the target device according to the appearance feature information;
if the integrity index exceeds an integrity index threshold, determining the device attribute information of the target device according to the appearance feature information; and
if the integrity index does not exceed the integrity index threshold, dividing the appearance feature information into a plurality of pieces of sub appearance feature information based on connected components of respective components or respective component groups in a separated state, performing comparison and matching according to the sub appearance feature information to acquire corresponding comparison and matching counts; sequencing the comparison and matching counts, and determining sub appearance feature information corresponding to a plurality of comparison matching counts at an end of a sequenced queue with comparison and matching counts being smaller than other end, as key appearance feature information, and determining the device attribute information of the target device according to the key appearance feature information.

In some embodiments, the number of the comparison and matching counts at the end of the sequenced queue with comparison and matching counts being smaller than the other end is determined according to the integrity index.

In some embodiments, the predicting and analyzing the entry-exit feature information to acquire a second target cleanliness index corresponding to the entry-exit feature information includes:
extracting a number of entering and exiting persons from the entry-exit feature information, and predicting entry-exit duration according to the number of entering and exiting persons; and
predicting a dust prediction increment according to the entry-exit duration and external environment information of the target plant workshop, and determining the second target cleanliness index corresponding to the entry-exit feature information according to the dust prediction increment and device parameters of each FFU device.

In some embodiments, the method further includes:
extracting clothing attribute information of respective entering and exiting persons from the entry-exit feature information, and calculating a target cleanliness coefficient index according to the clothing attribute information, where the clothing attribute information includes information of wearing a cleanroom suite, and information of not wearing the cleanroom suit.

The determining the second target cleanliness index corresponding to the entry-exit feature information according to the dust prediction increment and device parameters of each FFU device includes:
multiplying the dust prediction increment by the target cleanliness coefficient index, and determining the second target cleanliness index corresponding to the entry-exit feature information according to a multiplication calculation result and the device parameters of each FFU device.

In some embodiments, the controlling multiple FFU devices to filter air in the target plant workshop according to the cleanliness control parameter group includes:
if cleanliness control parameters are determined according to the first target cleanliness index, controlling all FFU devices in the target plant workshop to operate according to the cleanliness control parameters; and
if the cleanliness control parameters are determined according to the second target cleanliness index, controlling a plurality of FFU devices within a sector area at entrance and exit of the target plant workshop to operate in turn according to the cleanliness control parameters.

In some embodiments, the controlling a plurality of FFU devices within a sector area at entrance and exit of the target plant workshop to operate in turn according to the cleanliness control parameters includes:
determining a radius of the sector area according to the dust prediction increment;
determining operation sequence numbers of the FFU devices within the sector area according to a distance from each FFU device to a center of circle of the sector area, where a FFU device closest to the center of circle of the sector area has a minimum operation sequence number, and a FFU device farthest from the center of circle of the sector area has a maximum operation sequence number; and
controlling the FFU devices within the sector area to operate sequentially in ascending order of operation sequence numbers thereof according to the cleanliness control parameters.

The present disclosure provides an intelligent management system for a production environment of a plant, including a high-definition camera, a processing device, and a storage device, where the processing device is electrically connected to the storage device and the high-definition camera.

The high-definition camera is configured to acquire device attribute information of a target device stored in a target plant workshop, and entry-exit feature information of the target plant workshop, and transmit acquired information to the processing device.

The storage device is configured to store executable computer program codes.

The processing device is configured to execute the method above by calling the executable computer program codes in the storage device to generate cleanliness control parameters, and control a plurality of FFU devices to filter air in the target plant workshop according to the cleanliness control parameters.

The present disclosure provides an electronic device, including a memory in which executable program codes are stored, and a processor coupled to the memory. The processor is configured to call the executable program codes stored in the memory to execute the method above.

The present disclosure provides a computer readable storage medium. A computer program is stored on the storage medium. The computer program, when executed by a processor, is configured to execute the method above.

The present disclosure provides a computer program product. The computer program product can be executed by the processor to implement the method above.

The present disclosure has the beneficial effects that:

On the one hand, the control on the individualized cleanliness requirements of different target devices is achieved, specifically including controlling multiple FFU devices in the target plant workshop in a centralized manner to achieve high-precision control of the cleanliness of the target plant workshop. On the other hand, the impact of dust increase caused by the behaviors of entering and exiting the target plant workshop is effectively reduced.

### BRIEF DESCRIPTION OF THE DRAWINGS

The accompanying drawings are used for a better understanding of the technical solution, and do not constitute a limitation of the present disclosure.

FIG. 1 is a flow diagram of an intelligent management method for a production environment of a plant according to an embodiment of the present disclosure;

FIG. 2 is a structural diagram of an intelligent management system for production environment of a plant according to an embodiment of the present disclosure.

### DETAILED DESCRIPTION

Example embodiments of the present disclosure are described below with reference to the accompanying drawings, in which various details of the embodiments of the present disclosure are included to facilitate understanding, and should be considered as exemplary only. Accordingly, those of ordinary skill in the art will recognize that various changes and modifications can be made to the embodiments described herein without departing from the scope and spirit of the present disclosure. Likewise, descriptions of well-known functions and constructions may be omitted for clarity and conciseness.

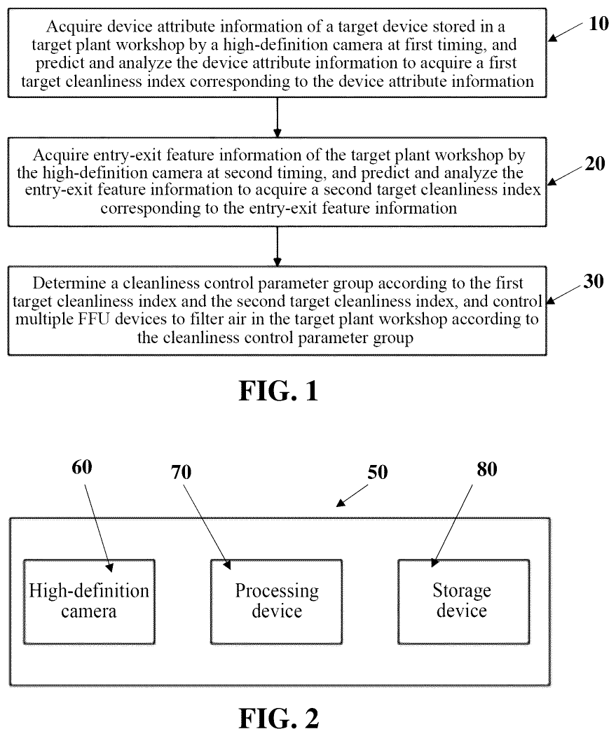

Referring to FIG. 1, an embodiment of the present disclosure provides an intelligent management method for a production environment of a plant, including:
at 10, acquiring device attribute information of a target device stored in a target plant workshop by a high-definition camera at first timing, and predicting and analyzing the device attribute information to acquire a first target cleanliness index corresponding to the device attribute information;
at 20, acquiring entry-exit feature information of the target plant workshop by the high-definition camera at second timing, and predicting and analyzing the entry-exit feature information to acquire a second target cleanliness index corresponding to the entry-exit feature information; and
at 30, determining a cleanliness control parameter group according to the first target cleanliness index and the second target cleanliness index, and controlling multiple FFU devices to filter air in the target plant workshop according to the cleanliness control parameter group.

The high-definition camera is configured to acquire the device attribute information of a target device stored in a target plant workshop and entry-exit feature information. Different types of target devices have different requirements on the cleanliness. The first target cleanliness index matched with the target device can be determined by predicting and analyzing the device attribute information, thus achieving appropriate cleanliness index. Therefore, the individualized requirements of the target device for the cleanliness can be satisfied, and the power consumption efficiency of the FFU device can be effectively reduced. The entry-exit of personnel and devices may exist in the target plant workshop. By acquiring, predicting and analyzing the entry-exit feature information, the corresponding second target cleanliness index can be determined, thus reducing the influence of dust increase caused by entry-exit behaviors. Therefore, on the one hand, the control on the individualized cleanliness requirements of different target devices is achieved, specifically including controlling multiple FFU devices in the target plant workshop in a centralized manner to achieve high-precision control of the cleanliness of the target plant workshop. On the other hand, the impact of dust increase caused by the behaviors of entering and exiting the target plant workshop is effectively reduced.

It should be noted that the first timing and the second timing may be the same period or moment, or different periods or moments. For the former case, it may be the period or moment when the target device enters the target plant workshop, during which the replacement of the target device and the entry-exit of the personnel and devices coexist. For the latter case, the first timing refers to the period or moment when the target device enters the target plant workshop, and the second timing refers to the period or moment after the target device enters the target plant workshop.

In some embodiments, the acquiring device attribute information of a target device stored in a target plant workshop by a high-definition camera includes:
acquiring appearance feature information of the target device stored in the target plant workshop by the high-definition camera, and analyzing an integrity index of the target device according to the appearance feature information;
if the integrity index exceeds an integrity index threshold, determining the device attribute information of the target device according to the appearance feature information;
if the integrity index does not exceed the integrity index threshold, dividing the appearance feature information into multiple pieces of sub appearance feature information based on connected components of respective components or respective component groups in a separated state, carrying out comparison and matching according to the sub appearance feature information to acquire corresponding comparison and matching counts; sequencing the comparison and matching counts, and determining the sub appearance feature information corresponding to multiple comparison matching counts at an end of a sequenced queue with comparison and matching counts being smaller than the other end as key appearance feature information, and determining the device attribute information of the target device according to the key appearance feature information.

The device attributes of the target device can be determined through the appearance feature information (such as structure, shape, color and texture) of the target device placed in the target plant workshop, that is, the appearance features of the target device are extracted through an image recognition technique, and then are compared and matched with the appearance features of known devices at the big data level in a designated database or Internet to determine the corresponding device attribute information.

Meanwhile, the target device may be placed in the target plant workshop in the form of a complete machine or several components to be assembled, and thus different comparison and matching calculation strategies needs to be employed. Firstly, the integrity index of the appearance feature information of the target device is evaluated, that is, the integrity of the appearance feature information of the target device located in a designated area (e.g., an area marked by yellow lines) is evaluated. When all sub appearance features of the target device are closely connected, it indicates that all components of the target device are in an installed and connected state, and the integrity is high at this time. When most of the sub appearance features of the target device are closely connected, it indicates that the components of the target device are in an installed and connected state in a whole, and a few components have not been installed and connected, and thus the integrity is medium at this time. When most of the sub appearance features of the target device are not closely connected, it indicates that the components the target device are in a state ready for installation and connection in a whole, and thus the integrity is low at this time. When the integrity index exceeds the integrity index threshold, the appearance feature information described above can be directly used for comparison and matching calculations to determine the device attribute information of the target device. Otherwise, the use of key appearance feature information of the target device for comparison and matching calculations can also determine the device attribute information of the target device.

When determining the key appearance feature information, the appearance feature information detected above is divided into multiple pieces of sub appearance feature information, each piece of sub appearance feature information is subjected to comparison and matching calculations according to the above methods. Since only local features are involved, multiple comparison and matching counts, i.e., hit counts, will be obtained. Next, the various comparison and matching counts are sequenced in ascending or descending order, and thus the acquired sequenced queue includes a small end and a big end with comparison and matching counts being bigger than the small end, and the sub appearance feature information corresponding to the multiple comparison and matching counts at the small end of the sequenced queue is determined as the key appearance feature information. The key appearance feature information refers to features of a component that best represents the type and attribute of the target device. For example, a component marked with “ASML” would indicate that the target device is a lithography machine. Finally, the device attribute information of the target device is determined according to each piece of key appearance feature information. So far, the determination of the device attribute information of the target device in an incomplete machine state is achieved.

It needs to be noted that the determination of the tight connection state between the components can be based on an adjacency relationship among multiple component images. If the component images are adjacent to each other, the tight connection state is considered high; otherwise, it is considered low. Additionally, the determination of the tight connection state between the components can be based on a distance between the center of one component and the centers of other components, the smaller the distance, the higher the tight connection state; the larger the distance, the lower the tight connection state. The tight connection state between the components can be determined by at least integrating the above two aspect factors.

Moreover, dividing the appearance feature information into multiple pieces of sub appearance feature information is based on connected components of respective components or respective component groups in a separated state. Specifically, when the integrity index does not exceed the integrity index threshold, at least part of the target device is in the form of components to be assembled, and these components to be assembled (i.e., components in a separated state) are separated from the components that have already been assembled (i.e., the component group in a separated state). The components to be assembled in the separated state and the component groups that has already been assembled can be delineated through connected component analysis, thus acquiring multiple pieces of sub appearance feature information in units of the connected component. Similar to the appearance feature information, the sub appearance feature information also includes appearance features such as a structure, a shape, a color, and a texture. The connected component involved in the present disclosure is a connected component concept in the image recognition field, that is, the pixel points belonging to the same target object are divided into one unit, thus forming a corresponding connected component corresponding to a single target object. The connected component is a pixel coverage region of the single target object in an image in actual.

In some embodiments, the number of comparison and matching counts at the small end of the sequenced queue is determined according to the integrity index.

The higher the integrity index, the greater the probability that the target device is in an installed and connected state, i.e., a complete machine state. In this case, it is necessary to use more key appearance feature information for matching calculations (i.e., it is closer to using complete appearance feature information for integrity index analysis of the target device), and thus the probability of an accurate hit (i.e., hitting a single match) can be improved, and then the device attribute information of the target device can be determined.

The lower the integrity index, the smaller the probability that the target device is in an installed and connected state, i.e., a complete machine state, In this case, it is necessary to use less key appearance feature information for matching calculations (i.e., it is farther away from using complete appearance feature information for integrity index analysis of the target device), and thus the number of hits can be properly increased, a situation that a real target is not recognized due to excessive matched features is avoided, and then the device attribute information of the target device can be determined accordingly.

For the two situations described above, in addition to the fact that the multiple target devices may be hit in the latter case, multiple target devices may also be hit in the former case. At this time, a manual selection link may be further set, the hit target devices and corresponding attribute information thereof can be output to the staff, and the staff can then perform confirmation and manual selection based on an on-site surveillance video photographed by the high-definition camera.

In some embodiments, the predicting and analyzing the entry-exit feature information to acquire a second target cleanliness index corresponding to the entry-exit feature information includes:
extracting the number of entering and exiting persons from the entry-exit feature information, and predicting the entry-exit duration according to the number of entering and exiting persons; and
predicting a dust prediction increment according to the entry-exit duration and external environment information of the target plant workshop, and determining the second target cleanliness index corresponding to the entry-exit feature information according to the dust prediction increment and device parameters of each FFU device.

The high-definition camera installed in the plant can be configured to promptly identify the personnel entering and exiting the target plant workshop, the number of entering and exiting persons can be extracted from the identified information, and the time required for this group of personnel to complete the entry-exit process, i.e., the entry-exit duration, can be predicted according to the number of entering and exiting persons, and during this entry-exit duration, a certain amount of dust is likely to enter the target plant workshop. According to the present disclosure, the dust prediction increment caused by this entry-exit process within the target plant workshop is predicted based on the entry-exit duration and the external environmental information (primarily dust concentration) of the target plant workshop, then the second target cleanliness index is determined according to the dust prediction increment and calibrated operating parameters of each FFU device, and each FFU device near the entrance and exit (e.g., within a 10-meter range) is controlled to operate according to the second target cleanliness index, and the newly increased dust can be adsorbed and filtered in time.

Apparently, the more the number of entering and exiting persons, the more the time for entering and exiting, and thus the entry-exit duration and the number of entering and exiting persons should conform to the proportional function.

In some embodiments, the method further includes:
extracting clothing attribute information of respective entering and exiting persons from the entry-exit feature information, and calculating a target cleanliness coefficient index according to the clothing attribute information, where the clothing attribute information includes information of wearing a cleanroom suite, and information of not wearing the cleanroom suit.

The determining the second target cleanliness index corresponding to the entry-exit feature information according to the dust prediction increment and the device parameters of each FFU device includes:
multiplying the dust prediction increment by the target cleanliness coefficient index, and determining the second target cleanliness index corresponding to the entry-exit feature information according to a multiplication calculation result and the device parameters of each FFU device.

The entering and exiting personnel may wear cleanroom suits or other types of casual clothing. When the personnel enter the target plant workshop with the cleanroom suits, it is indicated that the entrance of the target plant workshop is highly likely equipped with a dust removal device, and the amount of dust brought in the workshop by the personnel during the entry-exit process is minimal. Conversely, when the personnel enter the target plant workshop without the cleanroom suits, it is indicated that the entrance may not be equipped with the dust removal device, or the entering and exiting personnel do not comply with the dust removal criteria upon entry, and the amount of dust brought in the workshop by the personnel during the entry-exit process is significantly higher. For the former case, the target cleanliness coefficient index is set as a value less than 1, that is, the smaller target cleanliness coefficient index is used to correspondingly reduce the dust prediction increment. For the latter case, the target cleanliness coefficient index is set as a value greater than 1, that is, the larger target cleanliness coefficient index is used to correspondingly increase the dust prediction increment. In addition, there may be intermediate situations, that is, there are two types of clothing forms, namely, information of cleanroom suit and information of non-cleanroom suit. At this time, the degree of the target cleanliness coefficient index being greater than 1 can be determined according to the proportion of information that the clothing is the cleanroom suit, the higher the proportion, the closer the target cleanliness coefficient index is to 1, and the lower the proportion, the farther the target cleanliness coefficient index is from 1. Certainly, the determination method of the above target cleanliness coefficient index is only an example, and is not intended to limit the scope of protection of the present disclosure. The actual coefficient value can be specifically set according to the above size relationship.

Through above adjustment, the second target cleanliness index can be determined by the more accurate dust prediction increment and the operating parameters of each FFU device, which is conducive to the cooperative cooperation of multiple FFU devices to rapidly and timely filter and adsorb the incremental dust brought from the door, and reducing the influence on other devices in the target plant workshop as much as possible.

In some embodiments, the controlling multiple FFU devices to filter air in the target plant workshop according to the cleanliness control parameter group includes:
if the cleanliness control parameters are determined according to the first target cleanliness index, controlling all FFU devices in the target plant workshop to operate according to the cleanliness control parameters; and
if the cleanliness control parameters are determined according to the second target cleanliness index, controlling a plurality of FFU devices within a sector area at entrance and exit of the target plant workshop to operate in turn according to the cleanliness control parameters.

The first target cleanliness index corresponds to a situation that the target device is newly moved into the target plant workshop. In this case, more dust is brought into the target plant workshop due to the conveying, assembling, debugging and other operations. At this time, all FFU devices are controlled to operate according to the cleanliness control parameters to reach the environment with the cleanliness index required by the target device as soon as possible, thus facilitating the subsequent operation of the target device. The second target cleanliness index corresponds to a situation that a small amount of newly added dust is brought in by the entry-exit of the personnel after the target device is newly moved into the target plant workshop. At this time, multiple FFU devices located in the sector area at the entrance and exit of the target plant workshop are controlled to gradually enter a filtering and adsorption state to quickly adsorb and filter the newly entered dust in the entrance and exit area, thus reducing the influence on the target device in the target plant workshop.

In some embodiments, the controlling the plurality of FFU devices within a sector area at entrance and exit of the target plant workshop to operate in turn according to the cleanliness control parameters includes:
determining a radius of the sector area according to the dust prediction increment;
determining operation sequence numbers of the FFU devices within the sector area according to a distance from each FFU device to the center of circle of the sector area, where a FFU device closest to the center of circle of the sector area has the minimum operation sequence number, and the FFU device farthest from the center of circle of the sector area has the maximum operation sequence number; and
controlling the FFU devices within the sector area to operate sequentially in ascending order of operation sequence numbers thereof according to the cleanliness control parameters.

The radius of the sector area is determined according to the predicted dust prediction increment above. Apparently, the greater the dust prediction increment, the larger the sector area, that is, more FFU devices can be scheduled to participate in adsorption and filtration of the newly added dust. Operation sequence numbers of the FFU devices are determined according to the distances from the FFU devices to the center of circle of the sector area, the closer the distance, the smaller the operation sequence number of the FFU device, and the earlier of the start of the adsorption and filtration.

The advantages of above arrangements are that when the FFU device far away from the center of circle of the sector area performs adsorption and filtration, the generated airflow may cause the newly added dust at the entrance and exit to flow backward, making the dust closer to the target device and expand the influence of the dust on the performance parameters of the target device, such as operation accuracy. However, in the present disclosure, the FFU device closest to the entrance and exit is firstly controlled to carry out adsorption and filtration, such that most of the newly added dust can be adsorbed and filtered nearby, and a small part of the dust flows backward to the interior of the target plant workshop due to the airflow generated by adsorption and filtration, and as the filtration and adsorption of the subsequent FFU device are gradually started, these small parts of the dust that are flowed backward will be gradually adsorbed and filtered by other FFU devices that are far away from the center of circle of the sector area.

In addition, in addition to the above operation sequence number, an operation duration should be included, that is, the operation duration of each FFU device is different, and the operation duration can also be determined according to the above dust prediction increment, that is, the greater the dust prediction increment, the longer the operation duration of each FFU device; and the operation duration of each FFU device may be gradually reduced according to the above distance. Therefore, the effective operation efficiency of the FFU device can be improved, and ineffective operation duration can be reduced.

An embodiment of the present disclosure provides an intelligent management system 50 for a production environment of a plant as shown in FIG. 2, where the system 50 includes a high-definition camera 60, a processing device 70, and a storage device 80. The processing device 70 is electrically connected to the storage device 80 and the high-definition camera 60.

The high-definition camera 60 is configured to acquire device attribute information of a target device stored in a target plant workshop, and entry-exit feature information of the target plant workshop, and transmit the acquired information to the processing device 70.

The storage device 80 is configured to store executable computer program codes.

The processing device 70 is configured to execute the method above by calling the executable computer program codes in the storage device 80 to generate cleanliness control parameters, and control multiple FFU devices to filter air in the target plant workshop according to the cleanliness control parameters.

An embodiment of the present disclosure further provides an electronic device, including a memory in which executable program codes are stored, and a processor coupled to the memory. The processor is configured to call the executable program codes stored in the memory to execute the method above.

An embodiment of the present disclosure further provides a computer readable storage medium. A computer program is stored on the storage medium. The computer program, when executed by a processor, is configured to execute the method above.

An embodiment of the present disclosure further provides a computer program product. The computer program product can be executed by the processor to implement the method above.

Having thus described the basic concepts, it may be rather apparent to those skilled in the art that the foregoing detailed disclosure is intended to be presented by way of example only and is not limiting. Various alterations, improvements, and modifications may occur and are intended to those skilled in the art, though not expressly stated herein. Such alterations, improvements, and modifications are intended to be suggested by the present disclosure, and are within the spirit and scope of the exemplary embodiments of the present disclosure.

Meanwhile, certain terminology has been used to describe embodiments of the present disclosure. For example, the terms “one embodiment,” “an embodiment,” and/or “some embodiments” mean a particular feature, structure or characteristic described in connection with at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics in at least one embodiment of the present disclosure may be combined as suitable.

Further, it will be appreciated by those of ordinary sill in the art that various aspects of the present disclosure may be illustrated and described herein in a number of patentable classes or contexts, including any new and useful process, manufacture, or composition of matter, or any new and useful improvement thereof. Accordingly, various aspects of the present disclosure may be implemented entirely by hardware, implemented entirely by software (including firmware, resident software, micro-code, etc.) or a combination of software and hardware. The above hardware or software may be referred to herein as a “unit,” “module,” or “system.” Furthermore, various aspects of the present disclosure may take the form of a computer program product embodied in at least one computer readable medium, which includes computer readable program codes.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. The computer readable signal medium may be any computer readable medium that is not a computer readable storage medium and that may communicate, propagate, or transport a program for use by or in connection with an instruction execution system, apparatus, or device. The program code embodied on the computer readable signal medium may be transmitted using any appropriate medium, including radio, wireline, optical fiber cable, RF (radio frequency), or the like, or any suitable combination of the foregoing.

The computer program code required to execute the various features of the present disclosure may be implemented in one or any combination of multiple programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The programming code can be executed entirely on the user computer, run as an independent software package on the user computer, partially executed on the user computer and partially on a remote computer, or executed entirely on a remote computer or server. In the latter case, the remote computer may be connected to the user computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it should be understood that such details are solely for a description purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware apparatus, it may also be implemented as a software only solution, e.g., an installation of the described system on an existing server or mobile device.

Similarly, it should be appreciated that in the foregoing description of embodiments of the present disclosure, various features are sometimes grouped together in a single embodiment, figure, or description thereof for the purpose of simplifying the disclosure aiding in the understanding of at least one inventive embodiment of the present disclosure. This method of disclosure, however, is not to be interpreted as reflecting an intention that the claimed subject matter requires more features than those mentioned in the claims. Rather, the features of the embodiments are less than all the features disclosed in a single embodiment described above.

What is claimed is:

1. An intelligent management method for a production environment of a plant, comprising:
acquiring device attribute information of a target device stored in a target plant workshop by a high-definition camera at first timing, and predicting and analyzing the device attribute information to acquire a first target cleanliness index corresponding to the device attribute information;
acquiring entry-exit feature information of the target plant workshop by the high-definition camera at second timing, and predicting and analyzing the entry-exit feature information to acquire a second target cleanliness index corresponding to the entry-exit feature information; and
determining a cleanliness control parameter group according to the first target cleanliness index and the second target cleanliness index, and controlling a plurality of fan filter unit (FFU) devices to filter air in the target plant workshop according to the cleanliness control parameter group;
wherein the acquiring device attribute information of a target device stored in a target plant workshop by a high-definition camera comprises:
acquiring appearance feature information of the target device stored in the target plant workshop by the high-definition camera, and analyzing an integrity index of the target device according to the appearance feature information;
if the integrity index exceeds an integrity index threshold, determining the device attribute information of the target device according to the appearance feature information;
if the integrity index does not exceed the integrity index threshold, dividing the appearance feature information into a plurality of pieces of sub appearance feature information based on connected components of respective components or respective component groups in a separated state, performing comparison and matching according to the sub appearance feature information to acquire corresponding comparison and matching counts; sequencing the comparison and matching counts, and determining sub appearance feature information corresponding to a plurality of comparison matching counts at a small end of a sequenced queue as key appearance feature information, and determining the device attribute information of the target device according to the key appearance feature information;
the predicting and analyzing the entry-exit feature information to acquire a second target cleanliness index corresponding to the entry-exit feature information comprises:
extracting a number of entering and exiting persons from the entry-exit feature information, and predicting entry-exit duration according to the number of entering and exiting persons; and
predicting a dust prediction increment according to the entry-exit duration and external environment information of the target plant workshop, and determining the second target cleanliness index corresponding to the entry-exit feature information according to the dust prediction increment and device parameters of each FFU device.

2. The intelligent management method for the production environment of the plant according to claim 1, wherein a number of the comparison and matching counts at the small end of the sequenced queue is determined according to the integrity index.

3. The intelligent management method for the production environment of the plant according to claim 1, further comprising:
extracting clothing attribute information of respective entering and exiting persons from the entry-exit feature information, and calculating a target cleanliness coefficient index according to the clothing attribute information, wherein the clothing attribute information comprises information of wearing a cleanroom suite, and information of not wearing the cleanroom suit;
wherein the determining the second target cleanliness index corresponding to the entry-exit feature information according to the dust prediction increment and device parameters of each FFU device comprises:
multiplying the dust prediction increment by the target cleanliness coefficient index, and determining the second target cleanliness index corresponding to the entry-exit feature information according to a multiplication calculation result and the device parameters of each FFU device.

4. The intelligent management method for the production environment of the plant according to claim 3, wherein the controlling a plurality of FFU devices to filter air in the target plant workshop according to the cleanliness control parameter group comprises:
if cleanliness control parameters are determined according to the first target cleanliness index, controlling all FFU devices in the target plant workshop to operate according to the cleanliness control parameters; and
if the cleanliness control parameters are determined according to the second target cleanliness index, controlling a plurality of FFU devices within a sector area at entrance and exit of the target plant workshop to operate in turn according to the cleanliness control parameters.

5. The intelligent management method for the production environment of the plant according to claim 4, wherein the controlling a plurality of FFU devices within a sector area at entrance and exit of the target plant workshop to operate in turn according to the cleanliness control parameters comprises:
determining a radius of the sector area according to the dust prediction increment;
determining operation sequence numbers of the FFU devices within the sector area according to a distance from each FFU device to a center of circle of the sector area, wherein a FFU device closest to the center of circle of the sector area has a minimum operation sequence number, and a FFU device farthest from the center of circle of the sector area has a maximum operation sequence number; and
controlling the FFU devices within the sector area to operate sequentially in ascending order of operation sequence numbers thereof according to the cleanliness control parameters.

6. An intelligent management system for a production environment of a plant, comprising a high-definition camera, a processing device, and a storage device, wherein the processing device are electrically connected to the storage device and the high-definition camera;
the high-definition camera is configured to acquire device attribute information of a target device stored in a target plant workshop, and entry-exit feature information of the target plant workshop, and transmit acquired information to the processing device;
the storage device is configured to store executable computer program codes;
the processing device is configured to execute the method according to claim 1 by calling the executable computer program codes in the storage device to generate cleanliness control parameters, and control a plurality of FFU devices to filter air in the target plant workshop according to the cleanliness control parameters.

7. The intelligent management system for the production environment of the plant according to claim 6, wherein a number of the comparison and matching counts at the small end of the sequenced queue is determined according to the integrity index.

8. The intelligent management system for the production environment of the plant according to claim 6, the processing device is configured to execute following steps by calling the executable computer program codes in the storage device:
extracting clothing attribute information of respective entering and exiting persons from the entry-exit feature information, and calculating a target cleanliness coefficient index according to the clothing attribute information, wherein the clothing attribute information comprises information of wearing a cleanroom suite, and information of not wearing the cleanroom suit;
wherein the determining the second target cleanliness index corresponding to the entry-exit feature information according to the dust prediction increment and device parameters of each FFU device comprises:
multiplying the dust prediction increment by the target cleanliness coefficient index, and determining the second target cleanliness index corresponding to the entry-exit feature information according to a multiplication calculation result and the device parameters of each FFU device.

9. The intelligent management system for the production environment of the plant according to claim 8, the processing device is configured to execute following steps by calling the executable computer program codes in the storage device:
if cleanliness control parameters are determined according to the first target cleanliness index, controlling all FFU devices in the target plant workshop to operate according to the cleanliness control parameters; and
if the cleanliness control parameters are determined according to the second target cleanliness index, controlling a plurality of FFU devices within a sector area at entrance and exit of the target plant workshop to operate in turn according to the cleanliness control parameters.

10. The intelligent management system for the production environment of the plant according to claim 9, the processing device is configured to execute following steps by calling the executable computer program codes in the storage device:
determining a radius of the sector area according to the dust prediction increment;
determining operation sequence numbers of the FFU devices within the sector area according to a distance from each FFU device to a center of circle of the sector area, wherein a FFU device closest to the center of circle of the sector area has a minimum operation sequence number, and a FFU device farthest from the center of circle of the sector area has a maximum operation sequence number; and
controlling the FFU devices within the sector area to operate sequentially in ascending order of operation sequence numbers thereof according to the cleanliness control parameters.
